(19) United States
(12) Patent Application Publication
(10) Pub. No.: US 2015/0021940 A1
(43) Pub. Date: Jan. 22, 2015

(54) ENERGY ABSORBING VEHICLE COMPONENT

(71) Applicant: GM Global Technology Operations LLC, Detroit, MI (US)

(72) Inventors: Eric Roselli, Royal Oak, MI (US); Mark J. McGuire, Amherstburg (CA); Edward D. Moss, Commerce Township, MI (US); Daniel K. Davis, Williamston, MI (US); Peter M. Parlow, Columbus, MI (US); Giles D. Bryer, Northville, MI (US)

(21) Appl. No.: 14/307,776

(22) Filed: Jun. 18, 2014

Related U.S. Application Data
(60) Provisional application No. 61/857,088, filed on Jul. 22, 2013.

(51) Int. Cl. B60R 19/34; B60R 19/12

(52) U.S. Cl. CPC B60R 19/34; B60R 19/12; B60R 2019/1813
USPC 293/133

(57) ABSTRACT

A number of variations may include a product including an energy absorbing component for a vehicle comprising at least one of a crush can, an insert for a cross car beam or a front impact extension.

### CROSS-REFERENCE TO RELATED APPLICATIONS

This application claims the benefit of U.S. Provisional Application No. 61/857,088 filed Jul. 22, 2013.

### TECHNICAL FIELD

The field to which the disclosure generally relates to includes energy absorbing components for vehicles.

### BACKGROUND

Vehicles may be equipped with one or more components for absorbing energy.

### SUMMARY OF ILLUSTRATIVE VARIATIONS

A number of variations may include a crush can for a vehicle including a top rail portion overlying a bottom rail portion, the top rail portion having a plurality of wall portions forming an octagon and the bottom rail portion having a plurality of wall portions forming an octagon.

A number of variations may include a product including an energy absorbing component for a vehicle comprising at least one of a crush can, an insert for a cross car beam or a front impact extension.

In a number of variations the energy absorbing component for a vehicle may be an extrusion, and may be a single piece of continuous non-joined extruded metal.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a perspective view of a portion of a vehicle including an energy absorbing component according to a number of variations.

FIG. 2 is a cross-section taken along line 2-2 of FIG. 1 illustrating a crush can according to a number of variations of the invention.

FIG. 3 is a perspective view with portions removed illustrating a front energy absorbing insert according to a number of variations.

FIG. 4 is a perspective view illustrating a front impact extension according to a number of variations.

FIG. 5 is an illustration, in plan view, of a front impact extension according to a number of variations.

### DETAILED DESCRIPTION OF ILLUSTRATIVE VARIATIONS

The following description of the variations is merely illustrative in nature and is in no way intended to limit the scope of the invention, its application, or uses.

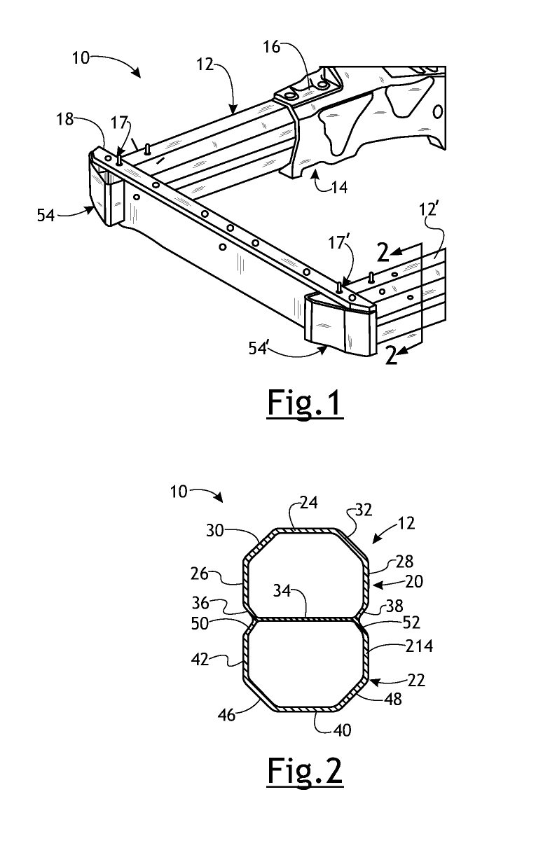

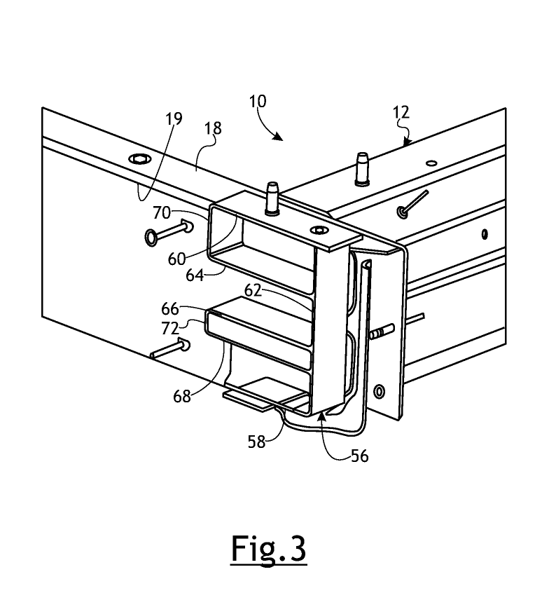

A number of variations are illustrated in FIG. 1 and may include a product 10 including an energy absorbing component for a vehicle. In a number of variations, the energy absorbing component for a vehicle may include a vehicle crush can 12 which may be attached to or connected to a vehicle rail system 14. In a number of variations, the crush can 12 may be connected to the vehicle rail system by a joint structure 16 having a recess formed therein for receiving a portion of the crush can 12. One end 17 of the crush can 12 may be connected to a cross car beam 18 such as a bumper. A similar second opposite crush can 12′ may also be connected to the rail system 14 and one end 17′ of the second crush can 12′ may be connected to the cross car beam 18. A front energy absorbing insert 56 (best seen in FIG. 3) may be received in the cross car beam 18 and aligned with the crush can 12. A second front energy absorbing insert 56′ may be received in the cross car beam 18 and aligned with the second crush can 12′. A first front impact extension 54 may be attached to the cross car beam 18 and aligned with the first crush can 12. A second front impact extension 54′ may be attached to the cross car beam 18 and aligned with the second crush can 12′.

Referring now to FIG. 2, the crush can 12, 12′ may each include a top portion 20 having a plurality of walls arranged in an octagon shape. A bottom rail portion 22 may include a plurality of walls arranged in an octagon shape. For example, the top rail portion 20 may include a top wall portion 24 and an opposite middle wall portion 34. A first side wall 26 may be provided and spaced from an opposite second side wall 28. A first angled wall portion 30 may join the first side wall 26 and the top wall 24, and a second angled side wall portion 32 may join the second side wall portion 28 and the top wall portion 24. A third angled wall portion 36 may join the first side wall portion 26 and the middle wall portion 34, and a fourth angled wall portion 38 may join the second side wall portion 28 and the middle side wall portion 34.

The bottom rail portion 22 may include a bottom wall portion 40 positioned opposite the middle wall portion 34. A third side wall portion 42 may be provided along with a spaced apart opposite fourth side wall portion 44. A fifth angled wall portion 46 may join the bottom wall portion 40 and the third side wall portion 42 and a sixth angled wall portion 48 may join the bottom wall portion 40 and the fourth side wall portion 44. A seventh angled wall portion 50 may join the third side wall portion 42 and the middle wall portion 34, and an eighth angled wall portion 52 may join the fourth side wall portion 44 and the middle wall portion 34. In a number of variations, the top wall portion 24, middle wall portion 34 and bottom wall portion 40 may be straight and parallel to each other. In a number of variations, the first side wall portion 26, second side wall portion 28, third side wall portion 42 and fourth side wall portion 44 may be straight and parallel to each other. In a number of variations, the first side wall portion 26 and the third side wall 42 portion may be straight and in the same line. In a number of variations, the second side wall portion 28 and the fourth side wall portion 44 may be straight and in the same line.

Referring now to FIG. 3, a number of variations may include a front energy absorbing insert 56, 56′ which may be received in a pocket or opening 19 of the cross car beam 18. The front energy absorbing insert 56 may include a bottom wall 58, an opposite top wall 60, and a first side wall 62 extending between the top wall 60 and bottom wall 58. Spaced apart first middle horizontal wall 64, second middle horizontal wall 66 and third middle horizontal wall 68 may be provided and may be connected to the first side wall 62. A first end wall 70 may be provided joining the top wall 60 and the first middle horizontal wall 64. A second end wall 72 may be provided joining the second middle horizontal wall 66 and a third middle horizontal wall 68. In a number of variations, the first side wall 62 may be aligned with the second side wall 28 and fourth side wall 44 of the crush can 12′. The top wall 60 may be aligned with the top wall 24 of the crush can 12′ and the bottom wall 54 may be aligned with the bottom wall 40 of the crush can 12′. The end wall 70 may be aligned with a portion of the first side wall 26 of the crush can 12, and the second end wall 72 may be aligned with a portion of the third side wall 42 of the crush can 12.

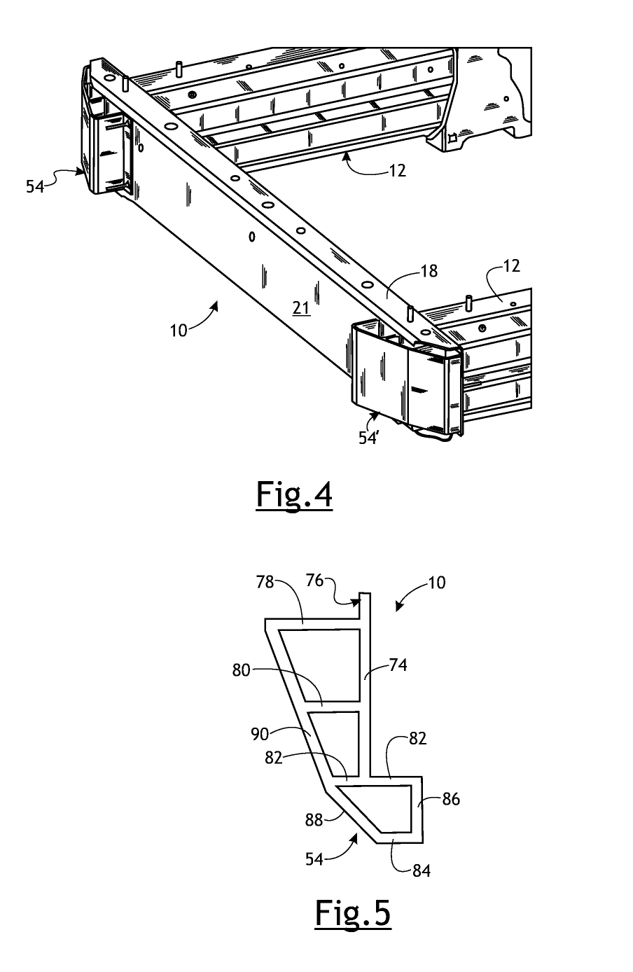

Referring now to FIG. 4, a first front impact extension 54 may be attached to the cross car being near one end thereof and a second front impact extension 54′ may be connected to the cross car beam 18 near a second end thereof. The first front impact extension 54 and second front impact extension 54′ may be constructed and arranged to include a first base wall 74 extending along a front face 21 of the cross car beam 18. The first base wall may provide a flange portion 76 extending inboard from a first crush wall 78 extending perpendicular from the first base wall 74. A second crush wall 80 may be spaced apart from the first crush wall 78 and may extend perpendicularly from the first base wall 74. A third crush wall 82 may extend from the first base wall 74 in the perpendicular direction. A portion of the third crush wall 82 may extend rearward from the first base wall 74 and may connect to a second base wall 76. The second base wall 76 may be parallel to the first base wall 74. A fourth crush wall 84 may extend perpendicularly from the second base wall 86. A first engagement wall may extend from the fourth crush wall 84 generally to the third crush wall 82. A second engagement wall 90 may extend from the third crush wall 82 to the first crush wall 78 connecting to the second crush wall 80. In a number of variations, the first crush wall 78 may be aligned with the first side wall 26 and third side wall 40 of the crush can 12′. In a number of variations, the third crush wall 82 may be aligned with the second side wall 28 and the fourth side wall 44 of the crush can 12′.

When the crush can 12 or 12′, front energy absorbing insert 56 or 56′ and front impact extension 54 or 54′ are provided and aligned respectively in a vehicle, the energy absorbing components increase the front crush length without lengthening the overall vehicle. In a number of variations, the front impact extensions 54, 54′ may be used to replace high density foam energy absorbers. In a number of variations, each of the crush can 12, 12′, front impact extensions 54, 54′, front energy absorbing insert 56, 56′ may each be made from an extruded metal, including but not limited to, aluminum or an aluminum alloy, and wherein each may be a single piece of continuous non-joined metal extrusion.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising: an energy absorbing component for a vehicle comprising a crush can for a vehicle including a top rail portion overlying a bottom rail portion, the top rail portion having a plurality of wall portions forming an octagon and the bottom rail portion having a plurality of wall portions forming an octagon.

Variation 2 may include a product as set forth in Variation 1 wherein the top rail portion includes a top wall portion and an opposite middle wall portion, a first side wall spaced from an opposite second side wall, a first angled wall portion joining the first side wall and the top wall, and a second angled side wall portion joining the second side wall portion and the top wall portion, a third angled wall portion joining the first side wall portion and the middle wall portion, and a fourth angled wall portion joining the second side wall portion and the middle side wall portion.

Variation 3 may include a product as set forth in any of Variations 1-2 wherein the bottom rail portion includes a bottom wall portion positioned opposite a middle wall portion, a third side wall portion and a spaced apart opposite fourth side wall portion, a fifth angled wall portion joining the bottom wall portion and the third side wall portion, and a sixth angled wall portion joining the bottom wall portion and the fourth side wall portion, a seventh angled wall portion joining the third side wall portion and the middle wall portion, and an eighth angled wall portion joining the fourth side wall portion and the middle wall portion.

Variation 4 may include a product as set forth in any of Variations 1-3 wherein the bottom rail portion includes a bottom wall portion positioned opposite the middle wall portion, a third side wall portion and a spaced apart opposite fourth side wall portion, a fifth angled wall portion joining the bottom wall portion and the third side wall portion, and a sixth angled wall portion joining the bottom wall portion and the fourth side wall portion, a seventh angled wall portion joining the third side wall portion and the middle wall portion, and an eighth angled wall portion joining the fourth side wall portion and the middle wall portion.

Variation 5 may include a product as set forth in any of Variations 1-4 wherein the first side wall portion, second side wall portion, third side wall portion and fourth side wall portion are straight and parallel to each other.

Variation 6 may include a product as set forth in any of Variations 1-5 wherein the first side wall portion and the third side wall portion are straight and in the same line.

Variation 7 may include a product as set forth in any of Variations 1-6 wherein the second side wall portion and the fourth side wall portion are straight and in the same line.

Variation 8 may include a product as set forth in any of Variations 1-7 wherein the top wall portion, middle wall portion and bottom wall portion are straight and parallel to each other.

Variation 9 may include a product as set forth in any of Variations 1-9 further comprising a front energy absorbing insert constructed and arranged to be received in a pocket or opening of a cross car beam, the front energy absorbing insert comprising a bottom wall and opposite top wall, and a first side wall extending between the top wall and the bottom wall, wherein bottom wall and opposite top wall, and a first side wall of the front energy absorbing insert are each respectively aligned with one of the plurality of wall portions of the top rail portion or the plurality of wall portions of the bottom rail portion.

Variation 10 may include a product as set forth in any of Variations 1-9 further comprising an energy absorbing component for a vehicle comprising a first front impact extension comprising a first base wall, a front engagement wall and at least one crush wall extending between the first base wall and the front engagement wall, and wherein the at least on crushable wall is aligned with one of the plurality of wall portions of the top rail portion or the plurality of wall portions of the bottom rail portion.

The above description of select variations within the scope of the invention is merely illustrative in nature and, thus, variations or variants thereof are not to be regarded as a departure from the spirit and scope of the invention.

What is claimed is:

1. A product comprising;
an energy absorbing component for a vehicle comprising a crush can for a vehicle including a top rail portion overlying a bottom rail portion, the top rail portion having a plurality of wall portions forming an octagon and the bottom rail portion having a plurality of wall portions forming an octagon.

2. A product as set forth in claim 1 wherein the top rail portion includes a top wall portion and an opposite middle wall portion, a first side wall spaced from an opposite second side wall, a first angled wall portion joining the first side wall and the top wall, and a second angled side wall portion joining the second side wall portion and the top wall portion, a third angled wall portion joining the first side wall portion and the middle wall portion, and a fourth angled wall portion joining the second side wall portion and the middle side wall portion.

3. A product as set forth in claim 1 wherein the bottom rail portion includes a bottom wall portion positioned opposite a middle wall portion, a third side wall portion and a spaced apart opposite fourth side wall portion, a fifth angled wall portion joining the bottom wall portion and the third side wall portion, and a sixth angled wall portion joining the bottom wall portion and the fourth side wall portion, a seventh angled wall portion joining the third side wall portion and the middle wall portion, and an eighth angled wall portion joining the fourth side wall portion and the middle wall portion.

4. A product as set forth in claim 2 wherein the bottom rail portion includes a bottom wall portion positioned opposite the middle wall portion, a third side wall portion and a spaced apart opposite fourth side wall portion, a fifth angled wall portion joining the bottom wall portion and the third side wall portion, and a sixth angled wall portion joining the bottom wall portion and the fourth side wall portion, a seventh angled wall portion joining the third side wall portion and the middle wall portion, and an eighth angled wall portion joining the fourth side wall portion and the middle wall portion.

5. A product as set forth in claim 4 wherein the first side wall portion, second side wall portion, third side wall portion and fourth side wall portion are straight and parallel to each other.

6. A product as set forth in claim 4 wherein the first side wall portion and the third side wall portion are straight and in the same line.

7. A product as set forth in claim 4 wherein the second side wall portion and the fourth side wall portion are straight and in the same line.

8. A product as set forth in claim 4 wherein the top wall portion, middle wall portion and bottom wall portion are straight and parallel to each other.

9. A product as set forth in claim 1 further comprising a front energy absorbing insert constructed and arranged to be received in a pocket or opening of a cross car beam, the front energy absorbing insert comprising a bottom wall and opposite top wall, and a first side wall extending between the top wall and the bottom wall, wherein bottom wall and opposite top wall, and a first side wall of the front energy absorbing insert are each respectively aligned with one of the plurality of wall portions of the top rail portion or the plurality of wall portions of the bottom rail portion.

10. A product as set forth in claim 1 further comprising an energy absorbing component for a vehicle comprising a first front impact extension comprising a first base wall, a front engagement wall and at least one crush wall extending between the first base wall and the front engagement wall, and wherein the at least on crushable wall is aligned with one of the plurality of wall portions of the top rail portion or the plurality of wall portions of the bottom rail portion.
